(19) United States
(12) Patent Application Publication
(10) Pub. No.: US 2026/0110259 A1
(43) Pub. Date: Apr. 23, 2026

(54) SYSTEMS AND METHODS FOR TREATMENT OF GAS ENGINE EXHAUST

(71) Applicant: CECO ENVIRONMENTAL IP INC., Dallas, TX (US)

(72) Inventors: Lars THEUNISSEN, Deventer (NL); Michiel MAKKEE, Rockanje (NL)

(21) Appl. No.: 19/168,236

(22) PCT Filed: Jan. 3, 2024
(86) PCT No.: PCT/US2024/010199

§ 371 Date: Sep. 23, 2025

(51) Int. Cl. F01N 3/28; B01D 53/94; B01D 53/96; F01N 3/10; F01N 3/20

(52) U.S. Cl. CPC F01N 3/2803; B01D 53/9431; B01D 53/9477; B01D 53/96; F01N 3/106; F01N 3/2013; F01N 3/2033; F01N 3/2066; B01D 2251/2062; B01D 2251/2067; B01D 2255/904; B01D 2257/404; B01D 2257/702; B01D 2258/018; F01N 2610/03; F01N 2610/04

(57) ABSTRACT

An exhaust treatment system comprises a reactor chamber configured to be fluidly coupled to an exhaust outlet of an engine, a regeneration chamber adjacent the reactor chamber, a regeneration system fluidly coupled to the regeneration chamber that is configured to generate a flow of regeneration fluid in the regeneration chamber, a first catalyst block, and a second catalyst block. The first catalyst block and the second catalyst block are configured to oxidize unburnt hydrocarbons in an exhaust stream from the engine. The treatment system can also include a combustible fluid injector for injecting a combustible fluid to raise the temperature of the first catalyst block and second catalyst block to a reaction temperature during use.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Engines may combust hydrocarbon gases (e.g., methane, ethane, propane, butane, etc., which may be collectively and generally referred to herein as “natural gas”) as a fuel source. Such engines may be utilized in a number of different industrial applications. For instance, natural gas-fired engines may be utilized for electrical power generation (e.g., such as at an electrical power plant, emergency back-up power generation for an office building, hospital, etc.). The main exhaust products are H₂O, CO₂, O₂, N₂. In some instances, the engine exhaust may include some amount of CO and NOₓ and un-combusted natural gas molecules such as methane (CH₄). It is generally undesirable from an environmental perspective to release these natural gas molecules into the atmosphere, and indeed within some jurisdictions, such emissions may violate environmental regulations.

### BRIEF SUMMARY

In some embodiments, an exhaust treatment system comprises a reactor chamber configured to be fluidly coupled to an exhaust outlet of an engine and a regeneration chamber adjacent the reactor chamber. The system also includes a first catalyst block configured to oxidize unburnt hydrocarbons in an exhaust stream from the engine when positioned in the reactor chamber, and a combustible fluid injector configured to disperse a combustible fluid within the reactor chamber upstream of the first catalyst block.

In some embodiments, a method comprises: positioning a first catalyst block in a reactor chamber; injecting a combustible fluid into the reactor chamber upstream of the first catalyst block; flowing an exhaust from an engine through the reactor chamber such that unburnt hydrocarbon molecules in the exhaust are oxidized via the first catalyst block; transferring the first catalyst block from the reactor chamber into a regeneration chamber that is adjacent the reactor chamber; heating the first catalyst block within the reactor chamber based on reacting the combustible fluid with the first catalyst block; transferring a second catalyst block from the regeneration chamber into the reactor chamber; and continuing to flow the exhaust from the engine through the reactor chamber such that the unburnt hydrocarbon molecules in the exhaust are oxidized via the second catalyst block.

In some embodiments, an exhaust treatment system comprises: a reactor chamber configured to be fluidly coupled to an exhaust outlet of an engine, a regeneration chamber adjacent the reactor chamber, and a regeneration system fluidly coupled to the regeneration chamber that is configured to generate a flow of regeneration fluid in the regeneration chamber. The system also includes a first catalyst block, and a second catalyst block. The first catalyst block and the second catalyst block are configured to oxidize unburnt hydrocarbons in an exhaust stream from the engine when positioned in the reactor chamber.

In some embodiments, a method comprises: positioning a first catalyst block in a reactor chamber, flowing an exhaust from an engine through the reactor chamber such that unburnt hydrocarbon molecules in the exhaust are oxidized via the first catalyst block, transferring the first catalyst block from the reactor chamber into a regeneration chamber that is adjacent the reactor chamber, transferring a second catalyst block from the regeneration chamber into the reactor chamber, continuing to flow the exhaust from the engine through the reactor chamber such that the unburnt hydrocarbon molecules in the exhaust are oxidized via the second catalyst block, and regenerating the first catalyst block with a stream of regeneration fluid in the regeneration chamber.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a schematic diagram of an exhaust treatment system according to some embodiments;

FIG. 2 is a side, cross-sectional view of an exhaust treatment system according to some embodiments;

FIG. 3 is a side, cross-sectional view of an exhaust treatment system according to some embodiments;

FIG. 4 is a side, cross-sectional view of an exhaust treatment system according to some embodiments;

FIG. 5 is a flow chart of a method for treatment of an exhaust from an engine according to some embodiments; and

FIGS. 6A and 6B are a flow chart of a method for treatment of an exhaust from an engine according to some embodiments.

### DETAILED DESCRIPTION

The following discussion is directed to various exemplary embodiments. However, one of ordinary skill in the art will understand that the examples disclosed herein have a broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. Further, when used herein (including in the claims) for a stated value, the words “about,” “generally,” “substantially,” “approximately,” and the like mean within a range of plus or minus 20% of the stated value.

As noted above, the emission of un-combusted natural gas molecules (e.g., methane-CH₄) and partial combusted hydrocarbons (e.g. formaldehyde, etc.) from the exhaust of a natural gas-fired engine may be undesirable and possibly impermissible. Catalysts may be employed to reduce the amount of methane (and/or other natural gas molecules) within the exhaust from a natural gas-fired engine. However, these catalysts have shown a tendency to quickly collect contaminants and deactivate under working conditions. Further, most catalyst for oxidizing unburnt or partially combusted hydrocarbons have a low relativity or destruction rate at the temperature of the exhaust gases (e.g., 350-400° C.) such that simply placing a catalyst in the path of the exhaust may not solve the emission issues. As a result, such methane reducing catalysts may generally require relatively frequent regeneration. In many applications, frequent catalyst regeneration is not practical or even possible. For instance, the rapid deactivation of an exhaust treatment catalyst may necessitate frequent shut downs of the engine to regenerate the catalyst, which frustrates the purpose of operating the natural gas-fired engine in the first place. Alternatively, an exhaust treatment system may include multiple, independent catalyst chambers and a complex network of piping and valves for selectively routing and re-routing the exhaust (e.g., so as to allow one or more catalysts to undergo regeneration while other catalysts contact the exhaust), which may add considerable expense to the exhaust treatment system. Therefore, the use of a methane reducing catalyst for treating the exhaust of a natural gas-fired engine may be considered unfeasible in many industrial applications.

Accordingly, embodiments disclosed herein include systems and methods for moving one or more catalyst between a reactor chamber (where the catalyst may contact exhaust from an engine to thereby reduce the amount of methane therein) and a regeneration chamber (for regenerating the catalyst). The regeneration chamber may be coupled to and adjacent the reactor chamber so as to reduce the complexity, size, and cost of the exhaust treatment system. In addition, in some embodiments, the exhaust treatment system may include multiple catalysts that may be independently moved between the reactor chamber and regeneration chamber such that methane reduction may be continued via at least one catalyst within the reactor chamber while at least one other catalyst is undergoing a regeneration process in the regeneration chamber. Accordingly, embodiments of the exhaust treatment systems described herein may allow a natural gas-fired engine to operate continuously for extended periods of time with constant (or nearly constant) methane reduction treatment.

In some aspects, the reduction reaction may be further promoted by maintaining the catalyst in the reactor chamber at a reaction temperature that is above the temperature of the exhaust. In order to heat the catalyst, one or more additional fluids can be injected into the exhaust stream at a point that is upstream of the catalysts. The additional fluids can include one or more combustible gases and/or liquids such as oxygenates that can be reacted on the catalyst to generate heat, though any combustible fluid can be used as described in more detail herein. The reaction of the additional gas on the catalyst can allow the surface of the catalyst to be heated to a reaction temperature above the temperature of the exhaust gases to reduce the (unburnt) hydrocarbons in the exhaust. This process can lengthen the time between regeneration cycles while also helping to increase the reduction efficiency of the catalyst.

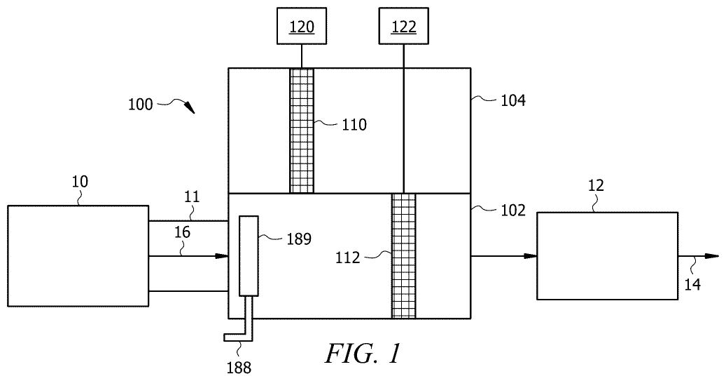

Referring now to FIG. 1, an exhaust treatment system 100 that is configured to treat an exhaust 16 emitted from an engine 10 is shown. Generally speaking, the engine 10 may comprise any suitable engine that may combust natural gas as a fuel source. In some embodiments, the engine 10 may comprise a natural gas-fired reciprocating engine; however, other engine designs or types are possible and contemplated in other embodiments (e.g., natural gas-fired turbines). Thus, unless expressly stated in the description or in the claims, the application of embodiments of exhaust treatment system 100 should not be limited to a particular type of natural gas-fired engine (e.g., such as a natural gas-fired reciprocating engine).

During operation of the engine 10, exhaust 16 is generated that is then communicated (e.g., via piping, tubing, hoses, manifolds, channels, etc.) to the exhaust treatment system 100 via an exhaust outlet 11. In general, the exhaust treatment system 100 includes a reactor chamber 102 and a regeneration chamber 104 that is adjacent the reactor chamber 102. A plurality (e.g., in this case two) catalyst blocks 110, 112 are positioned within the exhaust treatment system 100 and are selectively conveyed between and positioned within the reactor chamber 102 and regeneration chamber 104 via a plurality of conveyance assemblies 120, 122, respectively. In some embodiments, exhaust treatment system 100 may include a single catalyst block (e.g., catalyst block 110, 112) that is selectively conveyed between the reactor chamber 102 and the regeneration chamber 104 by a conveyance assembly (e.g., conveyance assembly 120, 122). In some aspects, an optional combustible fluid injector 189 can be used with the exhaust treatment system 100 to inject a combustible fluid in stream 188 into the reactor chamber 102. The injection of the combustible fluid is described in more detail herein.

Embodiments of the catalyst blocks 110, 112 are described in more detail below. However, generally speaking, the catalyst blocks 110, 112 include a catalyst material that is configured to oxidize hydrocarbon molecules (e.g., methane, which may be oxidized to form water and carbon dioxide) that may be present within the exhaust 16 so as to avoid releasing the un-combusted hydrocarbon modules into the atmosphere. In some embodiments, the catalyst blocks 110, 112 may comprise any suitable oxidation catalyst such as a Group 9, 10, and 11 element disposed on a suitable support or structure. Ultimately, any suitable catalyst material (or groups of materials) for the oxidation of hydrocarbons in the exhaust 16 may be used within the catalyst blocks 110, 112 in various embodiments.

Accordingly, when one or both of the catalysts blocks 110, 112 are positioned within the reactor chamber 102, exhaust 16 from engine 10 may be flown over and/or through the catalyst blocks 110, 112 so as to oxidize hydrocarbon molecules (e.g., methane) disposed therein. Thereafter, the treated exhaust 16 is flown through a muffler/silencer 12 and then eventually is emitted to the atmosphere via an outlet 14 (e.g., a flue pipe). The muffler 12 may comprise any suitable device or system for reducing sound waves that are emitted from the engine 10 via the exhaust 16. In some embodiments, the muffler 12 may be omitted. Thus, in some embodiments, outlet 14 may extend from the exhaust treatment system 100 (or any other suitable device, pipe, manifold, assembly that is disposed downstream of the exhaust treatment system 100 with respect to the flow of exhaust 16).

During these general operations with exhaust treatment system 100, the catalyst blocks 110, 112 may deactivate as a result of the contact with the exhaust 16 and the resulting chemical reaction(s). In some embodiments, the catalysts blocks 110, 112 may accumulate contaminants that are carried within the exhaust 16 (or that perhaps result from the chemical reactions occurring within and/or upstream of the catalyst blocks 110, 112). In some embodiments, the contaminants accumulating on the catalysts blocks 110, 112 may comprise coke, sulfur, lubricant products, etc. Regardless of the particular makeup of the contamination, over-time, the catalyst blocks 110, 112 have a reduced ability to catalyze the oxidation reaction in the exhaust 16 such that hydrocarbon molecules (or perhaps unacceptable levels thereof) may begin to breakthrough the catalyst blocks 110, 112 and flow out of the outlet 14. As a result, from time-to-time, the catalyst blocks 110, 112 may be subjected to a catalyst regeneration process whereby the catalyst block 110, 112 in question is conveyed or transported from the reactor chamber 102 into the regeneration chamber 104 via the corresponding conveyance assembly 120, 122, respectively, and contacted with a flow of regeneration fluid under suitable conditions so as to reactively remove contaminants from the catalyst blocks 110, 112 and reactivate the catalyst blocks 110, 112 for subsequent contact with the exhaust 16 as generally described above. While not intending to be limited by theory, the regeneration fluid can serve to change the oxidation/reduction state of the catalytic material. In some embodiments, the regeneration fluid may comprise hydrogen gas (e.g., H₂) that is contacted with the catalyst blocks 110, 112 at elevated temperature during the regeneration process so as to reactively remove the contaminants. In some instances, not intending to be bound by theory, the H₂ present in the regeneration fluid may react with contaminants such as sulfur that is built-up on the catalysts blocks 110, 112 at elevated temperature so as to form of gaseous components that can be removed from the catalyst blocks.

As shown in FIG. 1, the catalysts block 110, 112 may be independently moved between the reactor chamber 102 and regeneration chamber 104 via conveyance assemblies 120, 122. Specific examples of conveyance assemblies 120, 122 are described in more detail below. However, generally speaking, conveyance assemblies 120, 122 may comprise any suitable device or system for moving the catalyst blocks 110, 112, respectively, between the reactor chamber 102 and regeneration chamber 104. For instance, conveyance assembly 120, 122 may comprise hydraulic pistons, chain drives, belt drives, pulleys, etc. that are coupled to catalyst blocks 110, 112 and a suitable source of motive power (e.g., electrical power, hydraulic pressure, pneumatic pressure, etc.).

During the above-described exhaust treatment process, contaminants may build up relatively quickly on catalyst blocks 110, 112 such that frequent regeneration of the catalyst 110, 112 may be called for. To allow for constant operation of the engine 10 and continuous oxidation of hydrocarbons in the exhaust 16, conveyance assemblies 120, 122 may be configured to alternate the positions the catalysts blocks 110, 112 in the reactor chamber 102 and regeneration chamber 104. Specifically, the conveyance assembly 120 may be configured to position the catalyst block 110 in the reactor chamber 102 (to contact exhaust 16 and, therefore, facilitate the exhaust treatment process previously described above), while the catalyst block 112 is positioned in the regeneration chamber 104 (and is, therefore, subjected to a regeneration process as previously described above). Subsequently, the positions of the catalyst blocks 110, 112 may be switched such that the catalyst block 110 is moved from the reactor chamber 102 into the regeneration chamber 104 by conveyance assembly 120 and the catalyst block 112 is moved from the regeneration chamber 104 to the reactor chamber 102 by the conveyance assembly 122. Accordingly, by independently alternating the positions of catalyst blocks 110, 112 between the reactor chamber 102 and regeneration chamber 104, the engine 10 may be operated continuously for extended periods of time while still ensuring that unburnt hydrocarbon molecules are oxidized with one of the catalyst blocks 110, 112 as previously described above. Further details of example embodiments of the exhaust treatment system 100 will now be provided below.

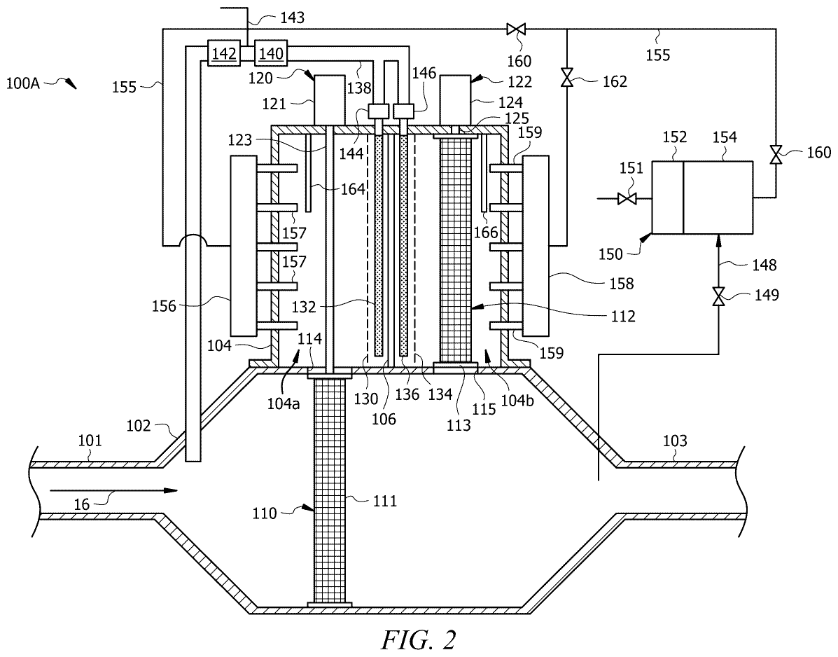

One example embodiment of an exhaust treatment system 100A that may be utilized as the exhaust treatment system 100 of FIG. 1 is shown in FIG. 2. Within the exhaust treatment system 100A, the reactor chamber 102 includes an inlet 101 and an outlet 103. The inlet 101 may be fluidly coupled to the exhaust outlet 11 of the engine 10 (see e.g., FIG. 1) such that exhaust 16 may be received from the engine 10 into the reactor chamber 102 via the inlet 101 and emitted from the reactor chamber 102 via the outlet 103. In addition, the regeneration chamber 104 may be engaged to the reactor chamber 102. In some embodiments, the regeneration chamber 104 may comprise a so-called “bolt-on” assembly that may be attached to an existing reactor chamber 102 for treating the exhaust 16 from engine 10 (see e.g., FIG. 1).

In this embodiment, the catalyst blocks 110, 112 may comprise monolithic supported catalysts. In particular, the catalysts blocks 110, 112 each comprise a frame or support 111, 113, respectively that is to support the catalyst material thereon. The catalyst blocks 110, 112 may include a honeycomb structure or any other suitable structure that allows a fluid (e.g., exhaust 16) to flow therethrough while contacting the catalyst material during operations.

In this embodiment, conveyance assemblies 120, 122 can comprise any suitable devices configured to raid and lower the catalyst blocks 110, 112. In some aspects, the conveyance assemblies 120, 122 can comprise hydraulic cylinders that include shafts that are coupled to catalyst blocks 110, 112. Thus, during operations, the shaft may be extended from or retracted toward hydraulic cylinder (e.g., via a change in hydraulic pressure within the cylinder) so as to move the catalyst block 110 between the reactor chamber 102 and the regeneration chamber 104. Similarly, during operations, the shaft may be extended from or retracted toward the hydraulic cylinder so as to move the catalyst block 112 between the reactor chamber 102 and the regeneration chamber 104. In other embodiments, the conveyance assemblies 120, 122 may comprise chain drives 121, 124 coupled to belts or chains 123, 125, which are in turn coupled to the catalyst blocks 110, 112. The conveyance assemblies 120, 122 can then be used to raise and lower the catalyst blocks 110, 112 during operation. For example, the chain 123 may be extended from or retracted toward the drive 121 (e.g., via a motor or gear) so as to move the catalyst block 110 between the reactor chamber 102 and the regeneration chamber 104. Similarly, during operations, the chain 124 may be extended from or retracted toward the drive so as to move the catalyst block 112 between the reactor chamber 102 and the regeneration chamber 104. In some embodiments, other conveyance mechanisms can be used including magnetic, pneumatic, or other types of drives to move the catalysts blocks 110, 112 as described herein.

The catalyst blocks 110, 112 may traverse between the reactor chamber 102 and the regeneration chamber 104 via corresponding ports or holes 114, 115, respectively. When the catalyst blocks 110, 112 are fully seated or positioned within the reactor chamber 102 or regeneration chamber 104, the frames 111, 113 of the catalysts blocks 110, 112, respectively, may engage with and cover the holes 114, 115, respectively, so that the flow of fluid between the reactor chamber 102 and regeneration chamber 104 via the holes 114, 115 is prevented (or at least restricted).

In addition, in this embodiment, the chains 123, 125 may extend through a wall of the regeneration chamber 104, and thus, suitable seals (e.g., a wiper box—not shown) may be disposed about the chains 123, 125 so as to prevent a loss of containment from the regeneration chamber 104 along the chains 123, 125 during operations. In some embodiments, the conveyance assemblies 120, 122 may be entirely positioned (or nearly entirely positioned) within the regeneration chamber 104 so as to avoid forming additional ports or other holes that may serve as a possible leak path for fluids from regeneration chamber 104 during operations.

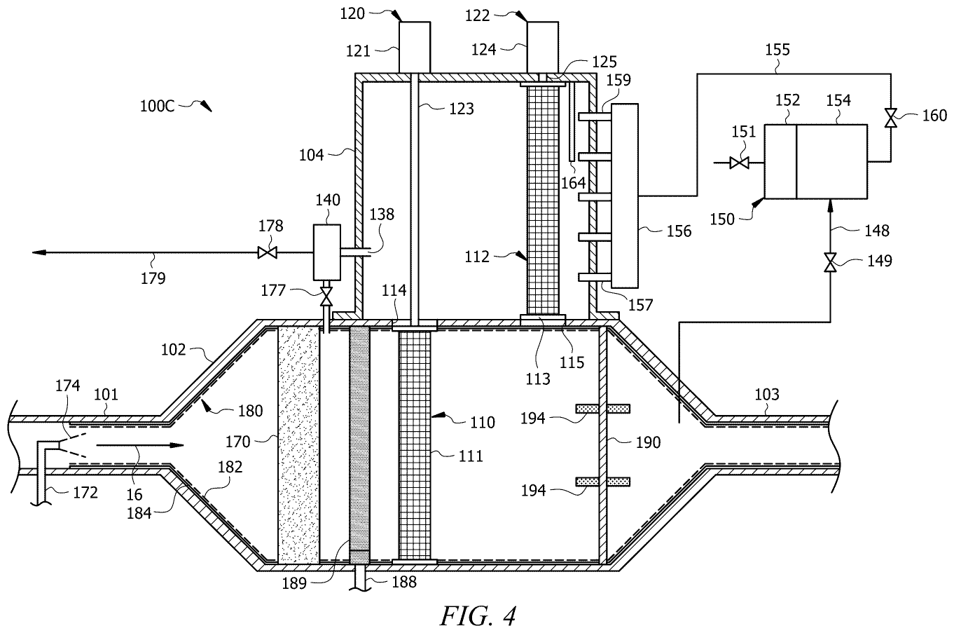

An optional partition or wall 106 can extend within the regeneration chamber 104 so as to separate the regeneration chamber 104 into a first sub-chamber 104a and a second sub-chamber 104b. The first sub-chamber 104a may selectively receive the catalyst block 110 therein, while the second sub-chamber 104b may selectively receive the catalyst block 112 therein. In some embodiments, for example, as will be disclosed with respect to FIG. 4, the partition 106 can be omitted.

A plurality of first headers 157 extend into the first sub-chamber 104a that are to emit the regeneration fluid into the first sub-chamber 104a during regeneration operations. Similarly, a plurality of second headers 159 extend into the second sub-chamber 104b that are to emit the regeneration fluid into the first sub-chamber 104a during regeneration operations.

The plurality of first headers 157 are fluidly coupled to a first manifold 156, and the plurality of second headers 159 are fluidly coupled to a second manifold 158. The first manifold 156 and the second manifold 158 are fluidly coupled (e.g., in parallel) to a regeneration fluid generation system 150. In some embodiments, the regeneration fluid generation system 150 may comprise a burner 154 and a blower 152. The burner 154 may combust natural gas or any her suitable fuel source to thereby produce the regeneration fluid that is flown toward the manifolds 156, 158 via a suitable network of piping 155. As previously described above, the regeneration fluid may comprise H₂, and thus, the operation of the burner 154 (e.g., the air-to-fuel ratio, pressure, temperature, fuel type, flow rate, combustion rate, etc.) may be tailored to produce a sufficient amount of H₂. In some embodiments, it may be desirable to ensure a sufficient amount of H₂ within the regeneration fluid, while also limiting the production of other, potentially non-desired products. In some embodiments, the burner 154 may be run rich, that is to say with a relatively low air-to-fuel ratio in order to achieve a desired chemical profile in the regeneration fluid. Valve 160, 162 may be disposed within the piping 155 so as to allow for selective flow of the regeneration fluid from the burner 154 to the manifolds 156, 158 (and thus headers 157, 159).

In some embodiments, the regeneration fluid generation system 150 may comprise any suitable system for the generation of a regeneration fluid comprising H₂ as previously described above. For example, any suitable system that can generate H₂ such as such dry or wet reforming systems, electrolysis systems, or the like that use hydrocarbons and/or carbon oxides can also be used. Thus, in some embodiments, the burner 154 may be omitted.

During operations, regeneration fluid may be emitted from burner 154 and flown to a select one of the manifolds 156, 158 via valves 160, 162 and piping 155. Subsequently, the regeneration fluid is flown into the corresponding sub-chamber 104a, 104b, via the headers 157, 159 coupled to manifolds 156, 158, respectively, so that the regeneration fluid may then contact the corresponding catalyst block 110, 112 to accomplish the regeneration process previously described above. Together, the headers 157, 159, manifolds 156, 158, piping 155, valves 160, 162, and regeneration fluid generation system 150 may be referred to as a regeneration assembly 150. Once contacted with the corresponding catalyst block 110, 112, valves 144 and 146 may be selectively actuated between closed and open positions so as to control the flow of the regeneration fluid from the sub-chambers 104a, 104b, respectively, into the return line 138 during operations.

The sub-chambers 104a, 104b both include a corresponding perforated outlet pipe 132, 136 that is to communicate the regeneration fluid from the regeneration chamber 104 and into a return line 138 following contact of the regeneration fluid with the catalyst blocks 110, 112, respectively. The perforated outlet pipes 132, 136 may comprise perforated pipes that receive the flow of regeneration fluid along the length thereof during operations. In addition, as shown in FIG. 2, each sub-chamber 104a, 104b includes a corresponding perforated plate 130, 134, respectively that is disposed downstream of the headers 157, 159, respectively, and upstream of the perforated pipes 132, 136, respectively, with respect to the flow of regeneration fluid within the sub-chambers 104a, 104b. As a result, following contact with the catalyst blocks 110, 112 within the sub-chambers 104a, 104b, respectively, the regeneration fluid may flow through the perforated plates 130, 134, into the perforated outlet pipes 132, 136 and into the return line 138. Without being limited to this or any other theory, the perforated plates 130, 134 and perforated outlet pipes 132, 136 may serve to evenly distribution of the flow of regeneration fluid across the catalyst blocks 110, 112, respectively, during regeneration operations. In some embodiments, one or both of the perforated plates 130, 134 and the perforated outlet pipes 132, 136 may be omitted from the sub-chambers 104a, 104b, and the regeneration fluid may be generated and flown through a single chamber.

In some embodiments, heating elements 164, 166 may be positioned within the sub-chambers 104a, 104b, respectively, so as to ensure a sufficient temperature within the sub-chambers 104a, 104b for regeneration operations. The heating elements 164, 166 may each comprise, in some embodiments, an electrical heating element comprising one or more electrically resistive coils. In some embodiments, the exhaust 16 may be at an elevated temperature, and heat transfer from the reactor chamber 102 may be sufficient so as to maintain the regeneration chamber 104 at a suitable temperature for the regeneration reactions described above. In addition, in some embodiments, heat may also be transferred into the regeneration chamber 104 via the regeneration fluid emitted from regeneration fluid generation system 150. Thus, in some embodiments, the heating elements 164, 166 may be omitted. In some embodiments, the regeneration reaction for the catalyst blocks 110, 112 may be carried out at a temperature ranging from approximately 400° C. to approximately 600° C., or ranging from approximately 450 to approximately 550° C. In some embodiments, the regeneration reaction for the catalyst blocks 110, 112 may be carried out at a pressure of approximately 1 bar (absolute) or less.

Referring still to FIG. 2, once the regeneration fluid has been emitted from the regeneration chamber 104 (e.g., via perforated outlet pipes 132, 136), the regeneration fluid may then flow through the return line 138 into the reactor chamber 102. In some embodiments (e.g., such as in the embodiment of FIG. 2), a fan 140 may be disposed along the return line 138 that is configured to draw the regeneration fluids from the regeneration chamber 104 (e.g., from the sub-chambers 104a, 104b) during operations. In addition, in some embodiments (e.g., such as the embodiment of FIG. 2), an additional catalyst 142 can be disposed along the return line 138 along with an air or oxygen inlet 143, which can be configured to oxidize H₂ and carbon monoxide (CO) within the regeneration fluid into water (H₂O) and carbon dioxide (CO₂) prior to flowing the regeneration fluid toward the reactor chamber 102.

In some embodiments, valves 144, 146 may be fluidly coupled between the perforated outlet pipes 132, 136 and return line 138. Valve 144, 146 may be actuated between closed and open positions so as to control the flow of regeneration fluid from the sub-chambers 104a, 104b, respectively, into the return line 138 during operations.

In FIG. 2, return line 138 is shown as providing fluid communication into or near the inlet 101 of the reactor chamber 102. In some aspects, return line 138 can also pass the regeneration gas to other locations such as at or near the outlet 103 of the reactor chamber 102 (e.g., as shown in FIG. 4), to a separate vent pipe, and/or into an intake of the engine or a separate combustion source (e.g., a separate engine, a flare, a burner, etc.). When the return line 138 passes the regeneration gas to a point upstream of the catalyst in the reactor chamber 102 and/or to a combustion source, the regeneration gas can be at least partially reacted to reduce any contaminants in the regeneration gas prior to the regeneration gas passing out of the system. In some aspects, the return line 138 can comprise a separate catalytic system configured to contact the regeneration gas with the catalyst and oxygen (e.g., from air or another source) to oxidize any contaminants in the regeneration gas.

As previously described, during operations, one of the catalysts blocks 110, 112 is positioned within the reactor chamber 102 during operation of the engine 10 (see e.g., FIG. 1). As a result, the exhaust 16 is flown into the reactor chamber 102 via inlet 101, and is flown through the corresponding one of the catalyst blocks 110, 112 so as to oxidize any hydrocarbon molecules (e.g., such as CH₄) within the exhaust 16 as previously described above. Thereafter, the treated exhaust 16 is expelled from the reactor chamber 102 via outlet 103.

Simultaneously, the other of the catalysts blocks 110, 112 is positioned within the regeneration chamber 104. Specifically, in the depiction of FIG. 2, the catalyst block 110 is positioned in the reactor chamber 102 (to therefore contact the exhaust 16), while the catalyst block 112 is positioned within the regeneration chamber 104 (particularly the second sub-chamber 104b). Accordingly, as the catalyst block 110 is contacting the exhaust 16 in the reactor chamber 102, the catalyst block 112 may undergo a regeneration process in the second sub-chamber 104b of the regeneration chamber 104. Specifically, as described above, regeneration fluid is produced at the regeneration fluid generation system 150 and flows, via piping 155, manifold 158, and headers 159 into second sub-chamber 104b. Thereafter, the regeneration fluid contacts the catalyst block 112 at suitable conditions (described above) in the second sub-chamber 104b so as to reactively remove contaminants thereon as previously described. The regeneration fluid is then flown out of second sub-chamber 104b via perforated outlet pipe 136 and return line 138 and eventually is emitted back into the reactor chamber 102 and/or an inlet of the engine so to flow out of the exhaust treatment system 100A along with the treated exhaust 16.

In some embodiments, during the regeneration process for the catalyst block 112, the fan 140 may be operated with the valve 146 in the open position (the valve 144 may be closed), but without producing regeneration fluid via the regeneration fluid generation system 150 (e.g., the burner 154 is off). This process may allow the piping 155, and second sub-chamber 104b to be flushed of any hydrogen or other potentially reactive or undesirable molecules (e.g., H₂, CO). This flushing operation may be carried with the catalyst block 112 positioned in the second sub-chamber 104b as shown in FIG. 2. After the flushing operation has been performed for a suitable amount of time (e.g., 30 seconds, 1 minute, 5 minutes, etc.), a flow of regeneration fluid may be initialized from the regeneration fluid generation system 150 (e.g., burner 154 may be turned on) while continuing to operate the fan 140 and maintain the valve 146 in the open position, so as to carry out the regeneration process as previously described. Once the regeneration process is completed (e.g., after the regeneration fluid has been flown through the catalyst block 112 at suitable conditions for a sufficient period of time to remove a desired amount of contaminants therefrom), the flow of regeneration fluid from regeneration fluid generation system 150 may be ceased (e.g., the burner 154 may be turned off), but the fan 140 may continue to operate with the valve 146 in the open position so as to once again flush the piping 155 and second sub-chamber 104b of any potentially reactive or otherwise undesirable molecules (e.g., H₂, CO, etc.). A similar process (e.g., flush, regenerate, flush, etc.) may be carried out when performing a regeneration process for the first catalyst block 110 in the first sub-chamber 104a; however, in these circumstances, the valve 146 may be maintained in the closed position, and the valve 144 may be placed in the open position so as to facilitate the flow of fluids from the first sub-chamber 104a into the return line 138.

Once the regeneration process for the catalyst block 112 is complete, the conveyance assembly 122 may actuate to move the catalyst block 112 from the second sub-chamber 104b of regeneration chamber 104 into the reactor chamber 102, and the conveyance assembly 120 may actuate to move the catalyst block 110 from the reactor chamber 102 into the first sub-chamber 104a of the regeneration chamber 104. The conveyance assemblies 120, 122 may move the catalyst blocks 110, 112 between the reactor chamber 102 and regeneration chamber 104 simultaneously, or may move one of the catalyst blocks 110, 112 between the reactor chamber 102 and regeneration chamber 104 at different times (e.g., so as to maintain at least one catalyst block 110, 112 in place within the reactor chamber 102 during operation of the engine 10). Regardless, once the catalyst blocks 110, 112 have been switched between the reactor chamber 102 and regeneration chamber 104 as described above, the exhaust 16 may then contact the catalyst block 112 within the reactor chamber 102 so as to oxidize unburnt hydrocarbon and partially combusted hydrocarbon molecules therein as described above, while the catalyst block 110 may undergo be subjected to a regeneration process within the first sub-chamber 104a of regeneration chamber 104 as described above. The positions of the catalyst blocks 110, 112 may be alternated between the reactor chamber 102 and regeneration chamber 104 in the manner described above so as to maintain contact between an active catalyst (e.g., catalyst block 110, 112) and the exhaust 16 during the entire period of operation for the engine 10 (see e.g., FIG. 1).

In some embodiments, the catalyst blocks 110, 112 may undergo a regeneration process within the regeneration chamber 104 at relatively frequency intervals. For instance, in some embodiments, the catalyst blocks 110, 112 may undergo a regeneration process within the regeneration chamber 104 every approximately 5 to 15 minutes. However, in other embodiments, each catalyst block 110, 112 may withstand contact with the exhaust 16 for longer periods before regeneration becomes necessary. Various factors may dictate the frequency of regeneration of the catalyst blocks 110, 112, such as, for instance, the flow rate and content of the exhaust, the size (e.g., thickness, volume, surface area, etc.) of the catalyst blocks 110, etc.

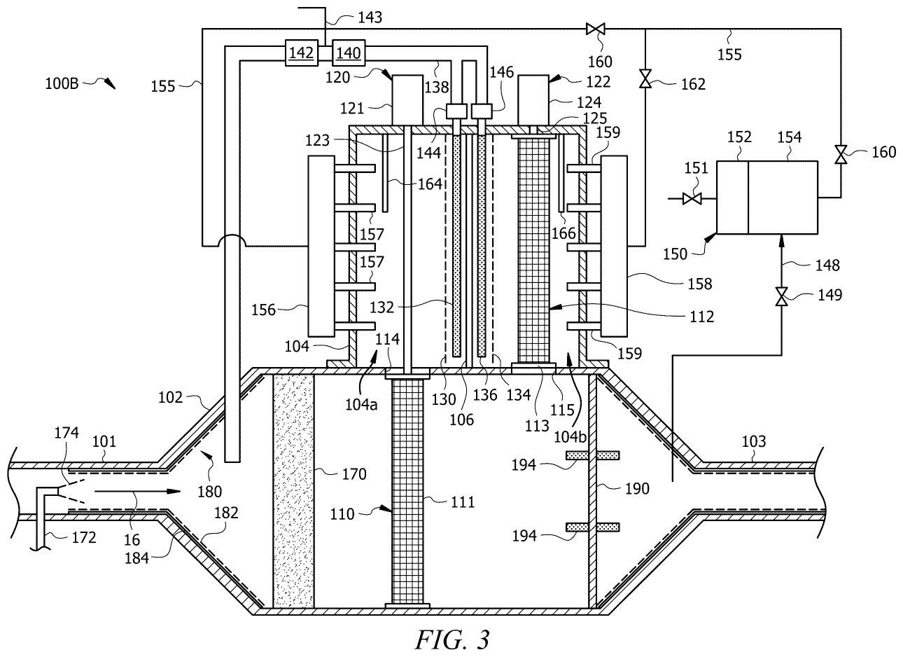

Another example embodiment of the exhaust treatment system 100B that may be utilized as the exhaust treatment system 100 of FIG. 1 is shown in FIG. 3. Generally speaking, the exhaust treatment system 100B of FIG. 3 shares many of the same features as the exhaust treatment system 100A of FIG. 2. As a result, these shared features are identified in FIG. 3 with the same reference numerals, and the discussion below will concentrate on the features of the exhaust treatment system 100B that are different from the exhaust treatment system 100A.

In particular, in addition to the catalyst blocks 110, 112, the reactor chamber 102 may also include an additional catalyst block 170. This additional catalyst block 170 may be positioned upstream of the catalyst blocks 110, 112 within the reactor chamber 102 (that is, when the catalyst blocks 110, 112 are positioned within the reactor chamber 102). In addition, this additional catalyst block 170 may be configured to reduce NOₓ within the exhaust 16, and thus may comprise any suitable catalyst material for these purposes (e.g., such as any suitable catalyst that is utilized with a selective catalytic reduction (SCR) system, non-selective catalytic reduction (NSCR) system, etc.). In some embodiments, this additional catalyst block 170 may comprise a support such as a ceramic or oxide (e.g., titanium oxide, aluminum oxide, cerium oxide, etc.) having a suitable catalyst material disposed thereon such as vanadium, molybdenum, tungsten, precious metals, or any other suitable NOx catalyst. During operations, the exhaust 16 may be contacted with the additional catalyst block 170 along with a reductant 174 which may comprise ammonia or urea so as to convert NOₓ within the exhaust to nitrogen gas (N₂) and water (H₂O) for ammonia and to nitrogen gas (N₂), carbon dioxide (CO₂), and water (H₂O) for urea. The reductant 174 may be injected into the reactor chamber 102 by a nozzle 172 (which may comprise multiple nozzles or injectors) disposed within inlet 101 and upstream of the third catalyst block 170. For this upstream NOx abatement there are also other options that are commercially available. The indicated SCR and NSCR are therefore not limited for this application for those who are skilled in the art of NOx abatement technology.

In addition, in some embodiments, the exhaust treatment system 100B may include one or more features for reducing vibrations and audible noise that may be emitted during operations. These noise-reducing features may comprise additional or alternative components to the muffler 14 previously described above (see e.g., FIG. 1). In particular, in some embodiments, the reactor chamber 102 may comprise a sound reduction liner 180. In particular, the sound reduction liner 180 may comprise a perforated sleeve 182 (which may comprise stainless steel in some embodiments) that generally conforms to the inner wall of the reactor chamber 102 (or at least a portion thereof), and a sound reduction medium 184 disposed between the perforated sleeve 182 and the inner wall of the reactor chamber 102. In some embodiments (e.g., such as in the embodiment of FIG. 3), the sound reduction liner 180 is positioned within the inlet 101 and a portion of the reactor chamber 102 that extends downstream from the inlet 101 (e.g., with respect to the flow of exhaust 16 therethrough). In some embodiments, the sound reduction material may comprise a fibrous material (e.g., metallic or non-metallic wool, or other suitable materials) that are to diffuse and dampen vibrations and the resulting sound waves associated therewith during operations. The use of the sound reduction material can serve to avoid the need for a separate noise abatement unit or silencer in the system downstream of the exhaust treatment system 100, which can save on costs and allow for a more compact system.

In addition, in some embodiments (e.g., such as in the embodiment of FIG. 3), a sound reduction barrier 190 may be inserted within the reactor chamber 102. In particular, the sound reduction barrier 190 may be disposed downstream of the catalyst blocks 110, 112 (that is, when the catalyst blocks 110, 112 are positioned within the reactor chamber 102). Generally speaking, the sound reduction barrier 190 may comprise a plate and a plurality of perforated flow pipes 194 extending through the plate. Thus, during operations, as the treated exhaust 16 flows through the catalyst block 110 and/or the catalyst block 112, it is then directed through the perforated pipes 194 (e.g., via the perforations in the pipes 194) and downstream of the plate. Without being limited to this or any other theory, by flowing the exhaust 16 through the perforations in the perforated pipes 194, and then subsequently re-expanding the exhaust within the reactor chamber 102 on the downstream side of the plate, vibrations (e.g., such as those associated with audible noise emitted from the exhaust treatment system 100B) may be partially or completely attenuated.

During operations with exhaust treatment system 100B, the exhaust 16 may contact one of the catalyst blocks 110, 112 within the reactor chamber 102 while the other of the catalyst blocks 110, 112 is positioned within the regeneration chamber 104 (e.g., in the corresponding sub-chamber 104a, 104b, respectively, as previously described) and undergoing a regeneration process as described above. In FIG. 3, return line 138 is shown as providing fluid communication into or near the inlet 101 of the reactor chamber 102. In some aspects, return line 138 can also pass the regeneration gas to other locations such as at or near the outlet 103 of the reactor chamber 102 (e.g., as shown in FIG. 4), to a separate vent pipe, and/or into an intake of the engine or a separate combustion source (e.g., a separate engine, a flare, a burner, etc.). Accordingly, these operations are not repeated in detail within the contexts of exhaust treatment system 100B in the interests of brevity.

Another example embodiment of the exhaust treatment system 100C that may be utilized as the exhaust treatment system 100 of FIG. 1 is shown in FIG. 4. Generally speaking, the exhaust treatment system 100C of FIG. 4 shares many of the same features as the exhaust treatment system 100A of FIG. 2 and/or the exhaust treatment system 100B of FIC. 3. As a result, these shared features are identified in FIG. 4 with the same reference numerals, and the discussion below will concentrate on the features of the exhaust treatment system 100C that are different from the exhaust treatment system 100A and exhaust treatment system 100B.

In the embodiment of FIG. 4, in addition to the catalyst blocks 110, 112 and the additional catalyst (de-NOx catalyst) block 170, the reactor chamber 102 may include a combustible fluid injector 189, which may be configured to inject a combustible fluid 188 into the reactor chamber 102. In some embodiments, the combustible fluid injector 189 may be generally configured to disperse the combustible fluid 188 within a portion of the reactor chamber 102 downstream from the additional (de-NOx catalyst) catalyst block 170 and upstream from the first and second catalyst blocks 110, 112. In various embodiments, the combustible fluid injector 189 may have any configuration suitable to disperse the combustible fluid 188. For example, in some embodiments, the combustible fluid injector 189 comprises an injection grid or one or more spray injectors. In various embodiments, the combustible fluid can comprise one or more oxygenates. In some aspects, the oxygenate may comprise an alcohol, an ether, or combinations thereof. Examples of alcohols include methanol, ethanol, isopropyl alcohol, n-butanol, or gasoline grade tert-butanol, or combinations thereof. Examples of ethers include methyl tert-butyl ether, tert-amyl methyl ether, tert-hexyl methyl ether, ethyl tert-butyl ether, tert-amyl ethyl ether, diisopropyl ether, and combinations thereof. In some embodiments, the combustible fluid can comprise various hydrocarbons such as volatile organic compounds (VOCs), light hydrocarbons such as ethane propane, butane, iso-butane, pentanes, etc. The use of light hydrocarbons can serve to generate heat at the catalyst while avoiding the introduction of contaminants such as sulfur or sulfur oxides that can deactivate the catalytic material. In some aspects, the combustible fluid can comprise syngas. Syngas comprises a mixture of hydrogen and carbon monoxide, and when contacted with the catalyst blocks can oxidize to produce water and carbon dioxide, thereby heating the catalyst blocks. The syngas may be produced for use with the system, or alternatively, syngas may be available and a side stream of the syngas can be used in the system. Furthermore, separate hydrogen (from electrolysis for example) can be used for this purpose.

Also in the embodiment of FIG. 4, and as similarly disclosed with respect to FIG. 3, the reactor chamber 102 may include a sound reduction liner 180, which may comprise the perforated sleeve 182 (for example, a stainless-steel sleeve) that generally conforms to the inner wall of the reactor chamber 102 (or at least a portion thereof), and the sound reduction medium 184 disposed between the perforated sleeve 182 and the inner wall of the reactor chamber 102. In some embodiments (e.g., such as in the embodiment of FIG. 4), the sound reduction liner 180 is disposed both within the inlet 101 of the reactor chamber 102 and the reactor chamber 102.

Also, in the embodiment of FIG. 4, and as similarly disclosed with respect to FIG. 3, a sound reduction barrier 190 may be inserted within the reactor chamber 102, for examples, disposed downstream of the of the catalyst blocks 110, 112 when the catalyst blocks 110, 112 are positioned within the reactor chamber 102.

Also, in the embodiment of FIG. 4, the regeneration chamber 104 includes a single chamber which is configured to selectively receive both catalyst blocks 110, 112. For example, as shown in FIG. 4, a plurality of headers 157 is fluidly coupled to a manifold 156, which is fluidly coupled to a regeneration fluid generation system 150. As similarly disclosed with respect to FIGS. 2 and 3, the regeneration fluid generation system 150 may comprise a burner 154 and a blower 152, configured such that the burner 154 may combust natural gas or any other suitable fuel source to thereby produce the regeneration fluid that is flowed toward the manifolds 156 via a suitable network of piping 155. As previously described above, the regeneration fluid may comprise H₂, and thus, the operation of the burner 154 (e.g., the air-to-fuel ratio, pressure, temperature, fuel type, flow rate, combustion rate, etc.) may be tailored to produce a sufficient amount of H₂. In some embodiments, it may be desirable to ensure a sufficient amount of H₂ within the regeneration fluid, while also limiting the production of other, potentially non-desired products (e.g., hydrocarbons, nitrogen oxides (NOₓ), SOx, etc.). In some embodiments, the burner 154 may be run rich, that is to say with a relatively low air-to-fuel ratio in order to achieve a desired chemical profile in the regeneration fluid. A valve 160 may be disposed within the piping 155 so as to allow the flow of the regeneration fluid from the burner 154 to the manifolds 156 and the header 157 may be selectively allowed or disallowed. Likewise, in the embodiment of FIG. 4, the regeneration chamber 104 as including a single heating element 164, though in some embodiments multiple heating elements may be employed.

Also, in the embodiment of FIG. 4, the regeneration fluid generation system 150 may be configured to selectively receive air from various sources. For example, as shown in FIG. 4, reactor exhaust line 155 may be opened to allow the regeneration fluid generation system 150 to receive ambient air (e.g., air external from the system 100C). Additionally, or alternatively, valve 149 may be opened to allow the regeneration fluid generation system 150 to receive air from an exhaust of the reactor chamber 102 via a reactor exhaust line 148. The reactor exhaust line may be taken from a relatively downstream part of the reactor chamber 102, such as the outlet 103 or proximate the outlet 103. Not intending to be bound by theory, because the exhaust communicated via the reactor exhaust line 148 is taken from the reactor chamber, the exhaust may be relatively depleted in oxygen, hydrocarbons, and nitrogen oxides. As such, when used as an input to the regeneration fluid generation system 150, a suitable regeneration fluid, comprising H₂ and free or substantially free of non-desired products (e.g., hydrocarbons, nitrogen oxides (NOₓ). In some aspects, the reactor exhaust line 148 may not be present.

As similarly discussed with respect to FIGS. 2 and 3, the regeneration chamber 102 may be in fluid communication with the return line 138, for example, to provide an outlet for the regeneration fluid from the regeneration chamber 104. In some embodiments, for example, as shown in the embodiment of FIG. 4, the fan 140 may be disposed along the return line 138 and is configured to draw the regeneration fluids from the regeneration chamber 104 during operations.

In addition, in some embodiments, for example, as shown in the embodiment of FIG. 4, the return line 138 may be selectively configurable to direct at least a portion of the regeneration fluid taken from the regeneration chamber 104 into a portion of the reactor chamber 102 downstream from the additional catalyst block 170 and upstream of the combustible fluid injector 189. Particularly, the return line 138 may provide a route of fluid communication, via the fan 140, from the regeneration chamber 104 and the reactor chamber 102. The return line 138 may include a valve 177 configured to selectively control the movement of the regeneration fluid from the regeneration chamber 104 to the reactor chamber 102. Alternatively, a valve 178 may selectively allow all or a portion of the regeneration fluid taken from the regeneration chamber 104 to form an exhaust 179, which may pass to an exhaust stack. The exhaust 179 may be used upon startup when the regeneration chamber 104 and catalyst blocks 110, 112 are being pre-heated such that there is no exhaust flow through the reactor chamber 102. For example, in operation, valve 177 and 178 may be operated so as to direct all or a portion of the regeneration fluid taken from the regeneration chamber to the reactor chamber 102 or to exhaust.

During operations with exhaust treatment system 100C, the exhaust 16 may contact one of the catalyst blocks 110, 112 within the reactor chamber 102 while the other of the catalyst blocks 110, 112 is positioned within the regeneration chamber 104 and undergoing a regeneration process as described above. Accordingly, these operations are not repeated in detail within the contexts of exhaust treatment system 100C in the interests of brevity.

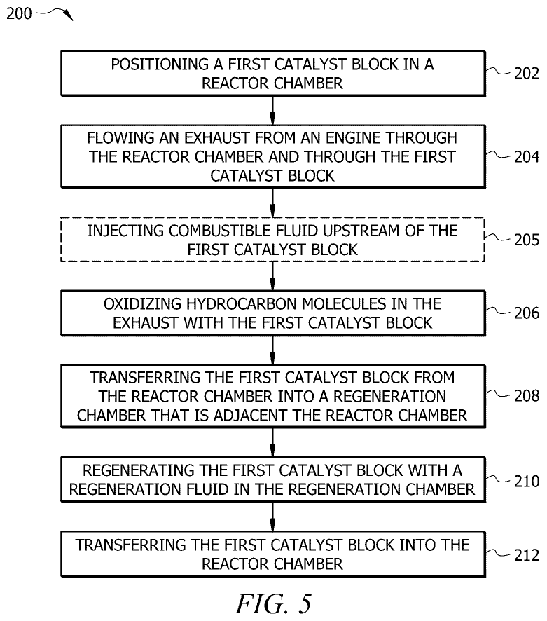

Referring now to FIG. 5, an embodiment of a method 200 for treating an exhaust from an engine according to some embodiments is shown. In some embodiments, method 200 may be practiced (e.g., partially or wholly) with embodiments of an exhaust treatment system as described herein (e.g., exhaust treatment systems 100, 100A, 100B, 100C). As a result, in describing the features of method 200, reference will be made to the features of exhaust treatment systems 100, 100A, 100B, 100C described above and shown in FIGS. 1-4. However, it should be appreciated that in some embodiments, method 200 may be performed using other systems and devices.

Initially, method 200 includes positioning a first catalyst block in a reactor chamber at 202. For instance, as described above for the exhaust treatment systems 100, 100A, 100B, 100C catalyst block 110 or catalyst block 112 may be positioned within the reactor chamber 102. Next, method 200 includes flowing an exhaust from an engine through the reactor chamber and through the first catalyst block at 204, and oxidizing the unburnt hydrocarbon molecules in the exhaust with the first catalyst block at 206. As described above for the exhaust treatment systems 100, 100A, 100B, 100C, exhaust 16 from engine 10 may be communicated to the reactor chamber 102 via the exhaust outlet 11 and inlet 101. When exhaust 16 enters the reactor chamber 102, it is directed through the catalyst block 110, 112 that is positioned therein, such that the unburnt hydrocarbon molecules (e.g., methane) in the exhaust 16 may be oxidized as described above. In some aspects, an oxidant can be introduced upstream of the catalyst block 110, 112 to heat the catalyst block 110, 112 during the oxidizing as part of the method.

The method 200 can also include optionally injecting a combustible fluid upstream of the first catalyst block at 205. As described herein, the use of a combustible fluid can allow the combustible fluid to react with the catalyst to raise the temperature of the catalyst above that of the exhaust. The higher temperatures can allow the catalyst to operate at a higher destruction efficiency than only operating at the temperature of the exhaust.

Method 200 also includes transferring the first catalyst block from the reactor chamber into a regeneration chamber that is adjacent the reactor chamber at 208. For the exhaust treatment systems 100, 100A, 100B, the catalyst blocks 110, 112 are transferred between the reactor chamber 102 and the regeneration chamber 104 via conveyance assemblies 120, 122, respectively.

Next, method 200 includes regenerating the first catalyst block with a regeneration fluid in the regeneration chamber at 210, and transferring the first catalyst block into the reactor chamber at 212. As previously described above for the exhaust treatment systems 100, 100A, 100B, once a catalyst block 110, 112 is positioned within the corresponding sub-chamber 104a, 104b, respectively, of the regeneration chamber 104, a regeneration fluid (e.g., such as a regeneration fluid including H₂) is flown through the catalyst block 110, 112 so as to reactively remove contaminants (e.g., sulfur) therefrom. After the regeneration process is complete, the catalyst block 110, 112 in question may then be transferred back into the reactor chamber 102 from the regeneration chamber 104 via the corresponding conveyance assembly 120, 122, so that the newly regenerated catalyst block 110, 112 may once again contact exhaust 16 and catalyze the unburnt hydrocarbon oxidation reaction described above.

In some embodiments, method 200 may also include positioning a second catalyst block in the reactor chamber, flowing the exhaust from the engine through the reactor chamber and through the second catalyst block, and oxidizing the unburnt hydrocarbon molecules in the exhaust with the second catalyst. As previously described for the exhaust treatment systems 100, 100A, 100B, 100C, when one of the catalyst blocks 110, 112 is disposed in the regeneration chamber 104, the other of the catalyst blocks 110, 112 may be positioned in the reactor chamber 102 so as to ensure continued oxidation of the unburnt hydrocarbons in the exhaust 16 during operations. In some embodiments, flowing the exhaust 16 through the second catalyst block and oxidizing hydrocarbon molecules in the exhaust with the second catalyst block may occur during the regenerating of the first catalyst block at 210.

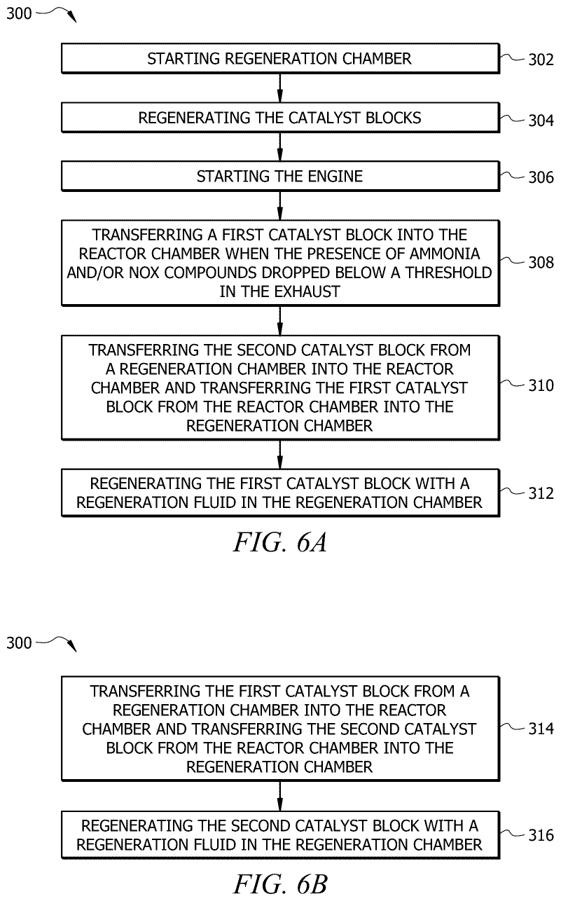

Referring now to FIGS. 6A and 6B, an additional or alternative embodiment of a method 300 for treating an exhaust from an engine according to some embodiments is shown. In some embodiments, method 300 may be practiced (e.g., partially or wholly) with embodiments of an exhaust treatment system as described herein (e.g., exhaust treatment systems 100, 100A, 100B, 100C). As a result, in describing the features of method 200, reference will be made to the features of exhaust treatment systems 100, 100A, 100B described above and shown in FIGS. 1-4. However, it should be appreciated that in some embodiments, method 300 may be performed using other systems and devices.

In the embodiment of FIGS. 6A-6B, the method 300 includes starting the regeneration chamber at 302. For instance, as described above for the exhaust treatment systems 100, 100A, 100B, and/or 100C, during start-up of the regeneration chamber, both catalyst block 110 and catalyst block 112 may be positioned within the regeneration chamber 102 and the engine 10 may be off. Valve 151 may be opened to allow ambient air in the regeneration fluid generation system 150 and the burner 154 ignited.

In some embodiments, method 300 includes pre-heating and/or regenerating the catalysts block at 304. For example, in some embodiments, the fan 140 may be started to draw heat from the burner 154 into the regeneration chamber 104 and heat the regeneration chamber to a regeneration temperature. In various embodiments, the regeneration temperature may be from about 400° C. to about 550° C., additionally or alternatively, from about 475° C. to about 525° C., additionally or alternatively, about 500° C. In embodiments where a heating element 164 is present, the heating element 164 may, in addition to or alternative to operation of the burner 154, be operated to achieve the regeneration temperature. When the regeneration chamber 104 reaches the desired regeneration temperature, valve 151 may be at least partially closed, causing the burner 154 to generate the regeneration fluid (e.g., a fluid rich in H₂ and CO). The catalyst blocks 110, 112 may be subjected to regenerating conditions (e.g., the regeneration temperature in the presence of the regeneration fluid) for a sufficient duration as to ensure regeneration of the catalyst blocks 110, 112, for example, from about 1 minutes to about 200 minutes, additionally or alternatively, from about 2 minutes to about 30 minutes. When regeneration of the catalyst blocks has been achieved, the burner 154 may be stopped and the regeneration fluid may be flushed from the regeneration chamber 104 (for example, with air, via valve 151). After flushing the regeneration chamber 104, with valve 151 open, the burner 154 may be reignited and the fan 140 operated to cause the regeneration chamber 104 to be heated to a catalyst preheating temperature. In various embodiments, the catalyst preheating temperature may be from about 350° C. to about 450° C., additionally or alternatively, from about 375° C. to about 425° C., additionally or alternatively, about 375° C. Not intending to be bound by theory, by preheating the catalyst block(s) 110 and/or 112 prior to use in the reactor chamber 102, the overall performance and longevity of the catalyst blocks may be improved.

In some embodiments, method 300 includes starting the engine at 306, such that exhaust 16 flows through the reactor chamber 102. In some embodiments, upon starting the engine 10, reductant 174 (e.g., urea and/or ammonia) may be injected into the reactor chamber 102. In some embodiments, following start-up of the engine 10 and injection of reductant 174 into the exhaust, the presence of ammonia and/or NOx compounds in the exhaust 16, downstream from the additional (SCR) catalyst block, may be monitored.

In some embodiments, method 300 includes, transferring a first catalyst block into the reactor chamber when the presence of ammonia and/or NOx compounds drops below a threshold in the exhaust at 308. For example, when the presence of ammonia and/or NOx compounds in the exhaust 16, downstream from the additional (SCR) catalyst block is less than a predetermined threshold, catalyst block 110 (alternatively, catalyst block 112) may be transferred into the reactor chamber 102 and combustible fluid 188 may be injected into the reactor chamber 102. The predetermined threshold can be an environmentally permitted limit that can be set by a local regulation or permit. While the predetermined threshold can vary from location to location, one of ordinary skill in the art would be able to ascertain the threshold based on the local rules along with the use of the present description. Not intending to be bound by theory, transferring catalyst block 110 (alternatively, catalyst block 112) into the reactor chamber 102 once the presence of ammonia and/or NOx compounds in the exhaust 16, downstream from the (additional (de-NOx catalyst) catalyst block, is less than the predetermined threshold, contact between the catalyst block 110 (alternatively, catalyst block 112) and NOx compounds and/or ammonia, which may be harmful to the catalyst blocks 110, 112, may be avoided. Additionally, when catalyst block 110 (alternatively, catalyst block 112) is moved into the reactor chamber 102, combustible fluid 188 may also be injected into the reactor 102. In some embodiments, for example, while catalyst block 110 (alternatively, catalyst block 112) is moved into the reactor chamber 102, catalyst block 112 (alternatively, catalyst block 110) may remain within the regeneration chamber 104, for example, catalyst block 112 (alternatively, catalyst block 110) may be preheated, as disclosed herein.

In some embodiments, method 300 includes transferring the first catalyst block from the reactor chamber into a regeneration chamber and transferring the second catalyst block from the regeneration chamber into the reactor chamber at 310. For example, the catalyst blocks 110, 112 may be transferred between the reactor chamber 102 and the regeneration chamber 104 via conveyance assemblies 120, 122, respectively. The exhaust 16 from the engine 10 may continue to be flown through the reactor chamber 102, and reductant 174 and combustible fluid 188 may continue to be introduced into the reactor chamber 102.

Also, in some embodiments, method 300 includes regenerating the first catalyst block in the regeneration chamber at 312. For example, as previously noted, the fan 140 may draw heat from the burner 154 into the regeneration chamber 104 and heat the regeneration chamber to the regeneration temperature and, in embodiments where a heating element 164 is present, the heating element 164 may, in addition to or alternative to operation of the burner 154, be operated to achieve the regeneration temperature. When the regeneration chamber 104 reaches the desired regeneration temperature, valve 151 may be at least partially closed, causing the burner 154 to generate the regeneration fluid (e.g., a fluid rich in H₂ and CO). The catalyst block 110 may be subjected to regenerating conditions (e.g., the regeneration temperature in the presence of the regeneration fluid) for a sufficient duration as to ensure regeneration of the catalyst block 110. When regeneration of the catalyst blocks has been achieved, the burner 154 may be stopped and the regeneration fluid may be flushed from the regeneration chamber 104 (for example, with air, via valve 151). After flushing the regeneration chamber 104, with valve 151 open, the burner 154 may be reignited and the fan 140 operated to cause the regeneration chamber 104 to be heated to the catalyst preheating temperature.

In some embodiments, method 300 includes transferring the second catalyst block from the reactor chamber into a regeneration chamber and transferring the first catalyst block from the regeneration chamber into the reactor chamber at 314. Again, as previously disclosed, the catalyst blocks 110, 112 may be transferred between the reactor chamber 102 and the regeneration chamber 104 via conveyance assemblies 120, 122, respectively. The exhaust 16 from the engine 10 may continue to be flown through the reactor chamber 102, and reductant 174 and combustible fluid 188 may continue to be introduced into the reactor chamber 102.

Also, in some embodiments, method 300 includes regenerating the second catalyst block in the regeneration chamber at 316, as previously disclosed.

The steps of transferring the catalyst blocks 110, 112 between the reactor chamber 102 and the regeneration chamber and regenerating and preheating the catalyst block within the regeneration chamber (e.g., steps 310, 312, 314, and 316) can be repeated iteratively, as disclosed previously.

The following embodiments are set forth as particular examples of the subject matter disclosed herein.

In a first aspect, an exhaust treatment system comprises: a reactor chamber configured to be fluidly coupled to an exhaust outlet of an engine; a regeneration chamber adjacent the reactor chamber; a first catalyst block, wherein the first catalyst block is configured to oxidize unburnt hydrocarbons in an exhaust stream from the engine, and a combustible fluid injector configured to disperse a combustible fluid within the reactor chamber upstream of the first catalyst block.

A second aspect can include the exhaust treatment system of the first aspect, further comprising: a first conveyance assembly configured to move the first catalyst block between the reactor chamber and the regeneration chamber.

A third aspect can include the exhaust treatment system of the first or second aspect, further comprising an additional catalyst upstream of the first catalyst block when disposed within the reactor chamber, wherein this additional catalyst is configured to reduce nitrogen oxides to nitrogen within the exhaust from the engine.

A fourth aspect can include the exhaust treatment system of any one of the first to third aspects, further comprising a reductant injector configured to disperse a reductant within the reactor chamber, wherein the reductant is configured to reduce nitrogen oxides into nitrogen

A fifth aspect can include the exhaust treatment system of any one of the first to fourth aspects, wherein the combustible fluid is selected from methanol, ethanol, isopropyl alcohol, n-butanol, or gasoline grade tert-butanol, an ether, ethane, propane, a butane, a pentane, hydrogen, syngas, or any combination thereof.

In a sixth aspect, a method comprises positioning a first catalyst block in a reactor chamber; injecting a combustible fluid into the reactor chamber upstream of the first catalyst block; flowing an exhaust from an engine through the reactor chamber such that unburnt hydrocarbon molecules in the exhaust are oxidized via the first catalyst block; heating the first catalyst block within the reactor chamber based on reacting the combustible fluid with the first catalyst block; transferring a second catalyst block from the regeneration chamber into the reactor chamber; transferring the first catalyst block from the reactor chamber into a regeneration chamber that is adjacent the reactor chamber and continuing to flow the exhaust from the engine through the reactor chamber such that the unburnt hydrocarbon molecules in the exhaust are oxidized via the second catalyst block.

A seventh aspect can include the method of the sixth aspect, further comprising: before positioning the first catalyst block in the reactor chamber, regenerating the first catalyst block in the regeneration chamber.

An eighth aspect can include the method of the seventh aspect, wherein regenerating the first catalyst block comprises: heating the regeneration chamber to from about 400° C. to about 600° C.; and contacting the first catalyst block and the second catalyst block with the regeneration fluid, wherein the regeneration fluid is enriched in hydrogen gas.

A ninth aspect can include the method of the eighth aspect, further comprising: before positioning the first catalyst block in the reactor chamber and after regenerating the first catalyst block, preheating the first catalyst block, wherein preheating the first catalyst block comprises heating the regeneration chamber to from about 350° C. to a temperature in the range between 400 and 450° C.

A tenth aspect can include the method of any one of the sixth to ninth aspects, further comprising: before positioning a first catalyst block in a reactor chamber, monitoring an amount of ammonia and/or NOx compounds in the reactor chamber; and positioning the first catalyst block into the reactor chamber when the amount of ammonia and/or NOx compounds is less than a threshold.

In an eleventh aspect, an exhaust treatment system comprises: a reactor chamber configured to be fluidly coupled to an exhaust outlet of an engine; a regeneration chamber adjacent the reactor chamber; a regeneration system fluidly coupled to the regeneration chamber that is configured to generate a flow of regeneration fluid in the regeneration chamber; a first catalyst block; and a second catalyst block, wherein the first catalyst block and the second catalyst block are configured to oxidize unburnt hydrocarbons in an exhaust stream from the engine when positioned in the reactor chamber.

A twelfth aspect can include the exhaust treatment system of the eleventh aspect, wherein the regeneration system comprises a burner and the regeneration fluid comprises hydrogen.

A thirteenth aspect can include the exhaust treatment system of the eleventh aspect, wherein the regeneration system comprises a dry reforming system, a wet reforming system, an electrolysis system, or a combination thereof.

A fourteenth aspect can include the exhaust treatment system of the twelfth aspect, wherein the regeneration system comprises a manifold that is fluidly coupled to the burner, and a plurality of headers extending from the manifold that are configured to direct the regeneration fluid into the regeneration chamber.

A fifteenth aspect can include the exhaust treatment system of the fourteenth aspect, comprising a fan configured to draw the regeneration fluid from the regeneration chamber into a return line coupled to the reactor chamber, an inlet of the engine, or an inlet of a separate catalytic oxidation system.

A sixteenth aspect can include the exhaust treatment system of the fifteenth aspect, wherein the return line is configured to selectively return at least a portion of the regeneration fluid into the reactor chamber upstream relative to the first catalyst block and the second catalyst block when disposed within the reactor chamber.

A seventeenth aspect can include the exhaust treatment system of any one of the eleventh to sixteenth aspects, further comprising: a first conveyance assembly configured to move the first catalyst block between the reactor chamber and the regeneration chamber; and a second conveyance assembly configured to move the second catalyst block between the reactor chamber and the regeneration chamber.

An eighteenth aspect can include the exhaust treatment system of any one of the eleventh to seventeenth aspects, further comprising an additional (SCR) catalyst upstream of the first catalyst block and the second catalyst block when disposed within the reactor chamber, wherein this additional catalyst is configured to reduce nitrogen oxides within the exhaust from the engine.

A nineteenth aspect can include the exhaust treatment system of the eighteenth aspect, further comprising a reductant injector configured to disperse a reductant within the reactor chamber, wherein the reductant is configured to reduce nitrogen oxides.

A twentieth aspect can include the exhaust treatment system of any one of the eleventh to nineteenth aspects, further comprising a combustible fluid injector configured to disperse a combustible fluid within the reactor chamber, wherein the combustible fluid is selected from methanol, ethanol, isopropyl alcohol, n-butanol, or gasoline grade tert-butanol, an ether, ethane, propane, a butane, a pentane, hydrogen, syngas, or any combination thereof.

In a twenty first aspect, a method comprises: positioning a first catalyst block in a reactor chamber; flowing an exhaust from an engine through the reactor chamber such that unburnt hydrocarbon molecules in the exhaust are oxidized via the first catalyst block; transferring a second catalyst block from the regeneration chamber into the reactor chamber; transferring the first catalyst block from the reactor chamber into a regeneration chamber that is adjacent the reactor chamber ; continuing to flow the exhaust from the engine through the reactor chamber such that the unburnt hydrocarbon molecules in the exhaust are oxidized via the second catalyst block; and regenerating the first catalyst block with a stream of regeneration fluid in the regeneration chamber.

A twenty second aspect can include the method of the twenty first aspect, further comprising: after regenerating the first catalyst block, transferring the first catalyst block from the regeneration chamber into the reactor chamber; transferring the second catalyst block from the reactor chamber into the regeneration chamber; continuing to flow the exhaust from the engine through the reactor chamber such that the unburnt hydrocarbon molecules in the exhaust are oxidized via the first catalyst block; and regenerating the second catalyst block with the stream of regeneration fluid in the regeneration chamber.

A twenty third aspect can include the method of the twenty first or twenty second aspect, further comprising: before positioning the first catalyst block in the reactor chamber, starting the regeneration chamber, wherein, during starting the regeneration chamber, the first catalyst block and the second catalyst block are disposed in the regeneration chamber.

A twenty fourth aspect can include the method of the twenty third aspect, wherein starting the regeneration chamber comprises: opening a valve to allow air-flow to a burner; igniting the burner; and drawing heat from the burner into the regeneration chamber.

A twenty fifth aspect can include the method of the twenty fourth aspect, further comprising: before positioning the first catalyst block in the reactor chamber, regenerating the first catalyst block and the second catalyst block in the regeneration chamber.

A twenty sixth aspect can include the method of the twenty fifth aspect, wherein regenerating the first catalyst block and the second catalyst block comprises: heating the regeneration chamber to from about 400° C. to about 600° C.; and contacting the first catalyst block and the second catalyst block with the regeneration fluid, wherein the regeneration fluid is enriched in hydrogen gas.

A twenty seventh aspect can include the method of the twenty sixth aspect, further comprising: before positioning the first catalyst block in the reactor chamber and after regenerating the first catalyst block and the second catalyst block, preheating the first catalyst block and the second catalyst block, wherein preheating the first catalyst block and the second catalyst block comprises heating the regeneration chamber to from about 350° C. to about 450° C.

A twenty eighth aspect can include the method of any one of the twenty first to twenty seventh aspects, further comprising: before positioning a first catalyst block in a reactor chamber, monitoring an amount of ammonia and/or NOx compounds in the reactor chamber; and positioning the first catalyst block into the reactor chamber when the amount of ammonia and/or NOx compounds is less than a threshold.

A twenty ninth aspect can include the method of any one of the twenty first to twenty eighth aspects, further comprising: while the first catalyst block or the second catalyst block is present in the reactor chamber, injecting a combustible fluid into the reactor chamber upstream of the first catalyst block or the second catalyst block.

Accordingly, the embodiments disclosed herein have included systems and methods for moving a catalyst block (e.g., one of the catalyst blocks 110, 112) between a reactor chamber (e.g., reactor chamber 102) for treating an exhaust (e.g., exhaust 16) from a natural gas-fired engine (e.g., engine 10) with the catalyst block, and a regeneration chamber (e.g., regeneration chamber 104) for regenerating the catalyst block. In addition, as described above, at least some embodiments herein also allow for multiple catalyst blocks to be independently moved between the reactor chamber and the regeneration chamber so that the engine exhaust may contact a first catalyst block in the reactor chamber, while a second catalyst block is regenerated in the regeneration chamber. As a result, the systems and methods described herein may allow a for continuous or substantially continuous methane-reduction treatment of the engine exhaust, even when the engine is operated for extended periods of time.

The embodiments disclosed herein also include systems and methods for heating a catalyst block within a reactor chamber for treating exhaust gasses. A combustible fluid can be injected upstream of the catalyst block, and the combustible fluid can react with the catalyst to generate heat to raise the temperature of the catalyst above that of the exhaust. The heat can be generated at the surface of the catalyst to allow the unburnt fuel and byproducts to be oxidized more efficiently on the catalyst. This can allow the catalyst to operate for a longer time period than if not being heated while also improving the destruction efficiency of the catalyst system.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps. 1.-10. (canceled)

11. An exhaust treatment system, comprising:
a reactor chamber configured to be fluidly coupled to an exhaust outlet of an engine;
a regeneration chamber adjacent the reactor chamber;
a regeneration system fluidly coupled to the regeneration chamber that is configured to generate a flow of regeneration fluid in the regeneration chamber;
a first catalyst block;
a second catalyst block, wherein the first catalyst block and the second catalyst block are configured to oxidize unburnt hydrocarbons in an exhaust stream from the engine when positioned in the reactor chamber;
a first conveyance assembly configured to move the first catalyst block between the reactor chamber and the regeneration chamber; and
a second conveyance assembly configured to move the second catalyst block between the reactor chamber and the regeneration chamber.

12. The exhaust treatment system of claim 11, wherein the regeneration system comprises a burner and the regeneration fluid comprises hydrogen.

13. The exhaust treatment system of claim 11, wherein the regeneration system comprises a dry reforming system, a wet reforming system, an electrolysis system, or a combination thereof.

14. The exhaust treatment system of claim 12, wherein the regeneration system comprises a manifold that is fluidly coupled to the burner, and a plurality of headers extending from the manifold that are configured to direct the regeneration fluid into the regeneration chamber.

15. The exhaust treatment system of claim 14, comprising a fan configured to draw the regeneration fluid from the regeneration chamber into a return line coupled to the reactor chamber, an inlet of the engine, or an inlet of a separate catalytic oxidation system.

16. The exhaust treatment system of claim 15, wherein the return line is configured to selectively return at least a portion of the regeneration fluid into the reactor chamber upstream relative to the first catalyst block and the second catalyst block when disposed within the reactor chamber.

17. (canceled)

18. The exhaust treatment system of claim 11, further comprising an additional (SCR) catalyst upstream of the first catalyst block and the second catalyst block when disposed within the reactor chamber, wherein the additional catalyst is configured to reduce nitrogen oxides within the exhaust from the engine.

19. The exhaust treatment system of claim 11, further comprising a reductant injector configured to disperse a reductant within the reactor chamber, wherein the reductant is configured to reduce nitrogen oxides.

20. The exhaust treatment system of claim 11, further comprising a combustible fluid injector configured to disperse a combustible fluid within the reactor chamber, wherein the combustible fluid is selected from an oxygenate, a volatile organic compound, a light hydrocarbon, hydrogen, syngas, or any combination thereof.

21. A method, comprising:
positioning a first catalyst block in a reactor chamber;
flowing an exhaust from an engine through the reactor chamber such that unburnt hydrocarbon molecules in the exhaust are oxidized via the first catalyst block;
transferring a second catalyst block from the regeneration chamber into the reactor chamber via a second conveyance assembly;
transferring the first catalyst block from the reactor chamber into a regeneration chamber that is adjacent the reactor chamber via a first conveyance assembly;
continuing to flow the exhaust from the engine through the reactor chamber such that the unburnt hydrocarbon molecules in the exhaust are oxidized via the second catalyst block; and
regenerating the first catalyst block with a stream of regeneration fluid in the regeneration chamber to change an oxidation/reduction state of a catalytic material in the first catalyst block.

22. The method of claim 21, further comprising:
after regenerating the first catalyst block, transferring the first catalyst block from the regeneration chamber into the reactor chamber;
transferring the second catalyst block from the reactor chamber into the regeneration chamber;
continuing to flow the exhaust from the engine through the reactor chamber such that the unburnt hydrocarbon molecules in the exhaust are oxidized via the first catalyst block; and
regenerating the second catalyst block with the stream of regeneration fluid in the regeneration chamber.

23. The method of claim 21, further comprising:
before positioning the first catalyst block in the reactor chamber, starting the regeneration chamber, wherein, during starting the regeneration chamber, the first catalyst block and the second catalyst block are disposed in the regeneration chamber.

24. The method of claim 23, wherein starting the regeneration chamber comprises:
opening a valve to allow air-flow to a burner;
igniting the burner; and
drawing heat from the burner into the regeneration chamber.

25. The method of claim 24, further comprising:
before positioning the first catalyst block in the reactor chamber, regenerating the first catalyst block and the second catalyst block in the regeneration chamber.

26. The method of claim 25, wherein regenerating the first catalyst block and the second catalyst block comprises:
heating the regeneration chamber to from about 400° C. to about 600° C.; and
contacting the first catalyst block and the second catalyst block with the regeneration fluid, wherein the regeneration fluid is enriched in hydrogen gas.

27. The method of claim 26, further comprising:
before positioning the first catalyst block in the reactor chamber and after regenerating the first catalyst block and the second catalyst block, preheating the first catalyst block and the second catalyst block, wherein preheating the first catalyst block and the second catalyst block comprises heating the regeneration chamber to from about 350° C. to about 450° C.

28. The method of claim 21, further comprising:
before positioning a first catalyst block in a reactor chamber, monitoring an amount of ammonia and/or NOx compounds in the reactor chamber; and
positioning the first catalyst block into the reactor chamber when the amount of ammonia and/or NOx compounds is less than a threshold.

29. The method of claim 21, further comprising:
while the first catalyst block or the second catalyst block is present in the reactor chamber, injecting a combustible fluid into the reactor chamber upstream of the first catalyst block or the second catalyst block; and
heating a catalytically active material of the first catalyst block or the second catalyst block in the reactor chamber based on reacting the combustible fluid with the first catalyst block, or the second catalyst block, respectively.

30. The method of claim 29, wherein the combustible fluid is selected from methanol, ethanol, isopropyl alcohol, n-butanol, or gasoline grade tert-butanol, an ether, ethane, propane, a butane, a pentane, hydrogen, syngas, or any combination thereof.

31. The method of claim 29, wherein the combustible fluid is selected from an oxygenate, a volatile organic compound, a light hydrocarbon, hydrogen, syngas, or any combination thereof.
